(19) United States
(12) Patent Application Publication
(10) Pub. No.: US 2007/0001620 A1
(43) Pub. Date: Jan. 4, 2007

(54) Display apparatus

(75) Inventors: Sang-hoon Lee, Ulsan city (KR); Jeong-il Kang, Yongin-si (KR); Kyoung-geun Lee, Suwon-si (KR); Yung-jun Park, Yongin-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/452,211

(22) Filed: Jun. 14, 2006

(30) Foreign Application Priority Data
Jul. 1, 2005 (KR) 2005-0059378

(51) Int. Cl. H05B 41/24

(52) U.S. Cl. 315/247

(57) ABSTRACT

Provided is a display apparatus that includes a light source, that further includes a current generator for outputting a predetermined driving current. Further provided is a first path for supplying the driving current output by the current generator to the light source and a second path for intercepting the driving current supplied to the light source. In addition, a switch is provided for supplying the driving current output by the current generator either to the first path or to the second path and a controller is provided for controlling the switch to supply the driving current output by the current generator to the first path while the light source is turned on, and to supply the driving current to the second path while the light source is turned off. Thus, the present invention provides a display apparatus which improves a response time of electrical current when a light source is turned on and off, and thereby improves display quality.

### CROSS-REFERENCE TO RELATED APPLICATION

This application claims the benefit under 35 U.S.C. §119(a) of Korean Patent Application No. 2005-0059378, filed on Jul. 1, 2005, in the Korean Intellectual Property Office, the entire disclosure of which is hereby incorporated by reference.

### BACKGROUND OF THE INVENTION

1. Field of the Invention

The present invention relates to a display apparatus comprising a light source. More particularly, the present invention relates to a display apparatus, which improves a response time of electrical current while a light source is turned on and off, and thereby improves display quality.

2. Description of the Related Art

A display apparatus employs a light emitting diode (LED) instead of a conventional cold cathode fluorescent lamp (CCFL) as a light source in order to improve color performance. A display apparatus utilizing an LED light source produces more realistic colors.

The LED light source in a conventional display apparatus uses either a linear type of control or a switching type of control. A method of controlling an LED light source using the conventional linear type of control and switching type of control will be described with reference to FIGS. 1A and 1B.

In the conventional linear type of control, the display apparatus comprises a constant voltage source in order to generate a voltage to be supplied to the LED light source. Further provided is a switch to be switched on and off in order to supply an electrical current to the LED light source that corresponds to the voltage supplied by the constant voltage source. Additionally provided is a pulse width modulation (PWM) generator for turning the switch on and off. In the linear type control of an LED light source, a current “ia” of a linear region “a” corresponding to an initial stage of supply current flowing through the LED elements is supplied to the LED light source as shown in FIG. 1A. The current “ia” in the linear region “a” is always supplied to the LED light source, thereby causing a large voltage loss in the switch that continuously supplies the current “ia” in the linear region “a”, if the amount of the load current of the LED light source is large.

In the conventional switching type of control, the display apparatus comprises a constant current source to generate a current to be supplied to the LED light source. Further provided is a switch to be switched on and off to supply the current supplied by the constant current source to the LED light source. Additionally provided is a pulse width modulation (PWM) generator to turn the switch on and off. In the switching type of control of the LED light source, the current “ia” flows through the LED light source in intervals (t₁˜t₃ and t₅˜) when the PWM generator is turned on to thereby turn on the LED light source as shown in FIG. 1B. Also, a current of “0” flows through the LED light source during the interval (t₃˜t₅) which is when the PWM generator is turned off, so as to turn off the LED light source. The switch is turned on and off depending on the amount of the current flowing through the LED during the intervals (t₁˜t₃, and t₅˜) which is when the PWM generator is turned on, so that the current flowing in the LED light source fluctuates during the interval of t₂˜t₃ and the average current “ia” flows therein.

In the conventional switching type of control, the display apparatus is not affected by the amount of the LED light source's current load. However, in the conventional switching type of control, T₂ and T₁ become longer as shown in FIG. 1B. T₂ refers to the amount of time taken to make the current flowing through the LED light source become “0” at “t₃”, which is when the PWM generator is turned off. T₁ refers to the amount of time taken to make the current flowing through the LED light source become the average current “ia” at t₁ and t₅, which is when the PWM generator is turned on. Thus, the conventional display apparatus controlling the LED light source through the switching type of control may not have a quick response time when the LED light source is turned on and off.

Accordingly, there is a need for an improved display apparatus which improves a response time of electrical current flowing through a light source that is turned on and off.

### SUMMARY OF THE INVENTION

Exemplary embodiments of the present invention address at least the above problems and/or disadvantages and provide at least the advantages described below. Accordingly, an aspect of the present invention is to provide a display apparatus which improves a response time of electrical current flowing through a light source that is turned on and off.

The foregoing and/or other aspects of an exemplary embodiment of the present invention are also achieved by providing a display apparatus comprising a light source, further comprising a current generator for outputting a predetermined driving current. Further provided is a first path for supplying the driving current output by the current generator to the light source and a second path for intercepting the driving current supplied to the light source. In addition, a switch is provided for supplying the driving current output by the current generator either to the first path or to the second path and a controller is provided for controlling the switch to supply the driving current output by the current generator to the first path while the light source is turned on, and to supply the driving current to the second path while the light source is turned off.

According to an aspect of an exemplary embodiment of the present invention, the light source comprises a light emitting diode (LED).

According to an aspect of an exemplary embodiment of the present invention, the controller outputs a pulse width modulation (PWM) control signal to the switch to turn off the switch so as to supply the driving current output by the current generator to the first path while the light source is turned on, and to turn on the switch so as to supply the driving current to the second path while the light source is turned off.

According to an aspect of an exemplary embodiment of the present invention, the controller turns off the switch so as to supply the driving current supplied to the second path, to the light source through the first path when the light source is turned on again while the light source is turned off.

According to an aspect of an exemplary embodiment of the present invention, the first path and the second path are provided in parallel with each other, and the switch comprises a transistor which is provided in the second path and controlled to turn on and off by the controller.

According to an aspect of an exemplary embodiment of the present invention, the controller controls the current generator to be disabled when the display apparatus is turned off.

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other objects, features, and advantages of certain embodiments of the present invention will be more apparent from the following description taken in conjunction with the accompanying drawings, in which:

FIGS. 1A and 1B illustrate waveforms of an LED driving current of a conventional driving control method;

FIG. 2 is a control block diagram according to a display apparatus of an exemplary embodiment of the present invention; and

FIG. 3 illustrates a pulse width modulation (PWM) control signal, a current waveform of an inductor and a waveform of a light emitting diode (LED) driving current according to a control method of the display apparatus of an exemplary embodiment of the present invention.

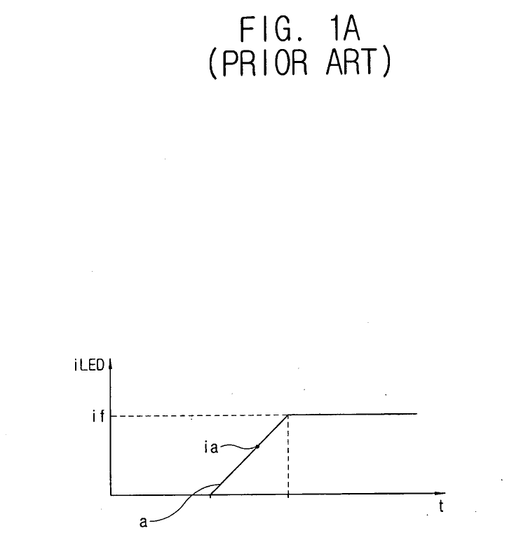

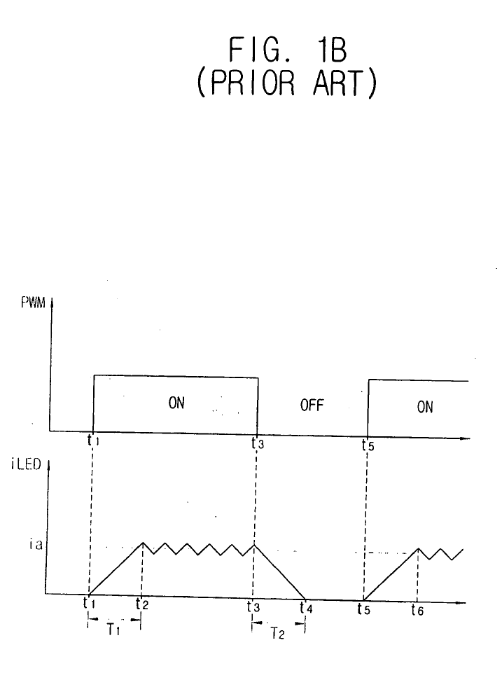

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention and are merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

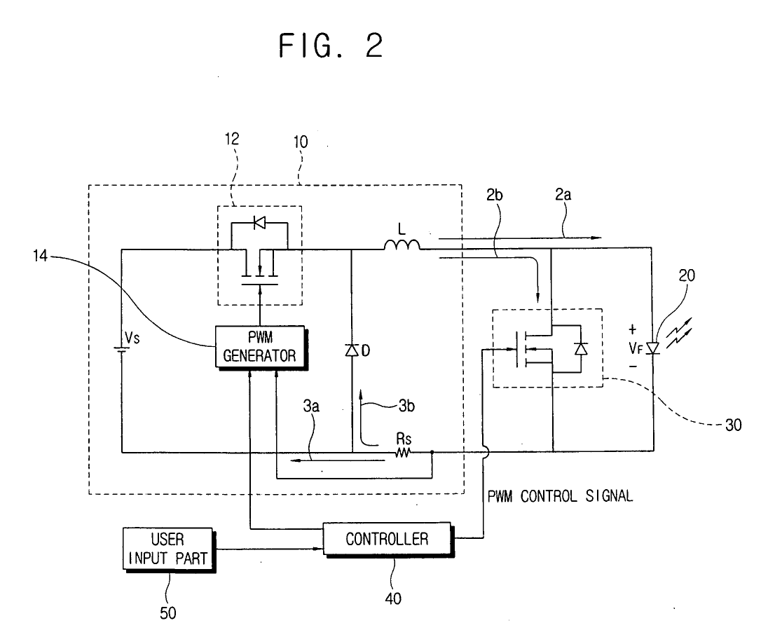

As shown in FIG. 2, a display apparatus according to an exemplary embodiment of the present invention comprises a light source 20; a current generator 10 to output a predetermined driving current; a first path 2a to supply the driving current output by the current generator 10 to the light source 20; a second path 2b to intercept the driving current supplied to the light source 20; a switch 30 to supply the driving current output by the current generator 10 either to the first path 2a or to the second path 2b; a controller 40 to control the switch 30 to supply the driving current output by the current generator 10 to the first path 2b when the light source 20 is turned on and to supply the driving current to the second path 2b when the light source 20 is turned off; and a user input part 50.

The light source 20 supplies light to a display part (not shown) which displays an image thereon. Preferably, the light source 20 according to an exemplary embodiment of the present invention comprises a light emitting diode (LED) which is provided in the first path 2a. The LED light source 20 may comprise a plurality of LED elements.

The current generator 10 provides a predetermined driving current to the LED light source 20. The current generator 10 comprises a power source V_{S} to generate power V_{F} that is used by the LED light source 20 A pulse width modulation (PWM) generator 14 is provided to control a current flow so as to control the luminance of the LED light source 20 according to a predetermined order value. A current maintaining switch 12 is provided to control a current supplied from the power source V_{S} to the LED light source 20. An inductor L is provided between an area where the first path 2a and the second path 2b are branched, and the current maintaining switch 12. A current detecting resistor R_{S} is provided between an area where the first path 2a and the second path 2b are combined, and the power V_{S}. A diode D is provided wherein an anode terminal is connected between the current detecting resistor R_{S} and the power source V_{S}, and a cathode terminal is connected between the current maintaining switch 12 and the inductor L.

The current maintaining switch 12 controls the current supplied from the power source V_{S} to the LED light source 20. Preferably, the current maintaining switch 12 is provided as a metal-oxide semiconductor field effect transistor (MOSFET). However, other types of switches may be used.

The PWM generator 14 PWM-controls the current maintaining switch 12 and allows the current generator 10 to output a constant driving current to maintain the luminance of the LED light source 20 according to the predetermined order value. The PWM generator 14 receives a turn-on control signal (the predetermined order value) of the LED light source 20 from the controller 40 at an initial stage of driving the display apparatus, and turns on the current maintaining switch 12. Also, the PWM generator 14 detects a comparison voltage supplied to the current detecting resistor R_{S}, and determines whether the current flowing to either the first path 2a or to the second path 2b is larger than the predetermined current value by comparing the detected comparison voltage and the predetermined order value. The PWM generator 14 turns off the current maintaining switch 12 if the detected comparison voltage is larger than the predetermined order value. After a predetermined period of time, the PWM generator 14 again turns on the current maintaining switch 12. As described above, the PWM generator 12 turns on the current maintaining switch 12 according to the control of the controller 40 at the initial stage of driving the display apparatus. The PWM generator 12 repeatedly turns on and off the current maintaining switch 12 based on the result of the comparison of the comparison voltage supplied to the current detecting resistor R_{S} and the predetermined order value, and the predetermined period of time. Thus, the current generator 10 may output the constant driving current while the display apparatus is driven, regardless of turning on and off of the LED light source 20.

If the display apparatus is not driven, the PWM generator 14 is controlled to be disabled by the controller 40. Preferably, the current generator 10 may not output the driving current.

The switch 30 supplies the driving current output by the current generator 10 to either the first path 2a or to the second path 2b. The switch 30 is provided in the second path 2b and is turned on and off by the PWM control signal of the controller 40. Preferably, a MOSFET is provided as the switch 30 to intercept the driving current supplied from the current generator 10 to the LED light source 20.

The controller 40 controls respective circuits (not shown) of the display apparatus to drive the display apparatus, and at the same time outputs the turn-on control signal (the predetermined order value) of the LED light source 20 to the PWM generator 14 when a power key of the user input part 50 of the display apparatus is manipulated via. Of course, a turn-on control signal can also be outputted when a wired or wireless control signal is received by the display apparatus.

The controller 40 outputs the PWM control signal to control the switch 30 so as to supply the driving current output by the current generator 10 to the first path 2a when the LED light source 20 is turned on, and to supply the driving current to the second path 2b when the LED light source 20 is turned off. That is, the controller 40 turns off the switch 30 to supply the driving current output by the current generator 10 to the LED light source 20 when the LED light source 20 is turned on, and turns on the switch 30 to supply the driving current supplied to the LED light source 20 to the second path 2b when the LED light source 20 is turned off.

Here, a process of turning on and off the LED light source 20 will be described as an exemplary embodiment of the present invention. If a blue color B is not required to display a desired image, the light sources red R and green G among the lights sources R, G and B are turned on to receive the driving current while the LED light source B is turned off so as not to receive the driving current.

The display apparatus according to an exemplary embodiment of the present invention may comprise a digital light processing (DLP) display, a liquid crystal display (LCD), a plasma display panel (PDP), a Liquid Crystal on Silicon (LCoS) display, or any other variant or display types that can display an image using an LED light source 20. Preferably, the display apparatus according to an exemplary embodiment of the present invention is a DLP display.

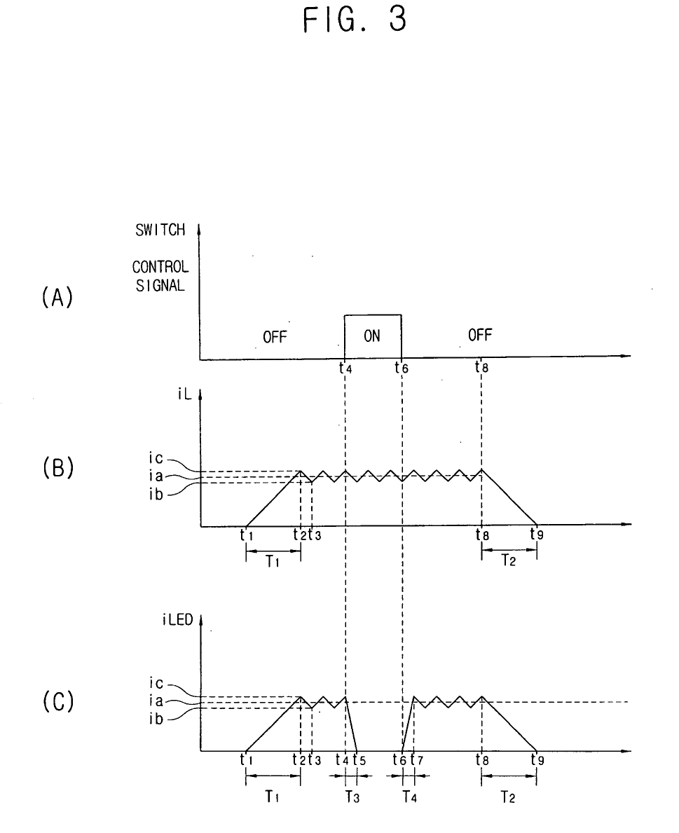

The method of controlling the LED light source 20 according to the display apparatus of an exemplary embodiment of the present invention will be described with reference to FIG. 3.

First, when the power key (not shown) of the display apparatus is manipulated so as to drive the display apparatus at a time t₁, the controller 40 controls the current generator 10 to output the driving current according to the predetermined order value. As the PWM generator 14 receives the turn-on control signal (the predetermined order value) from the controller 40 and turns on the current maintaining switch 12, the driving current is output. At this time, the controller 40 outputs the PWM control signal to turn off the switch 30 as shown in (A) of FIG. 3. The driving current output from the power V_{S} is charged in the inductor L through the current maintaining switch 12, so as to be supplied to the LED light source 20 provided in the first path 2a. Then, the driving current output from the LED light source 20 flows to a third path 3a through the current detecting resistor R_{S}. The flow path of the driving current output from the power source Vₛ is as follows: V_{S}→L→LED light source 20→R_{S}→V_{S}. Thus, at an initial stage of t₁˜t₂ when the LED light source 20 receives the driving current, the LED light source 20 is turned on and the current (refer to ‘B’ of FIG. 3) flowing through the inductor L and the current (refer to ‘C’ of FIG. 3) flowing in the LED light source 20 become larger. At the initial stage of driving the display apparatus, the response time T₁ of the LED light source 20 is similar to that of the conventional art.

The PWM generator 14 detects the comparison voltage supplied to the current detecting resistor R_{S}, and compares the detected comparison voltage and the predetermined order value. If the detected comparison voltage is larger than the predetermined order value at time t₂, the PWM generator 14 determines that the driving current flowing through the LED light source 20 is larger than a predetermined current value “ic” and turns off the current maintaining switch 12. Then, the current charged in the inductor L is supplied to the LED light source 20 through the first path 2a, and then flows to the diode D through the current detecting resistor R_{S} and the a fourth path 3b. The flow path of the current flowing through the inductor L is as follows: L→LED light source 20→R_{S}→D→L. Thus, the current (refer to ‘B’ of FIG. 3) flowing in the inductor L and the current (refer to ‘C’ of FIG. 3) flowing in the LED light source 20 becomes smaller from the time t₂.

After turning off the current maintaining switch 12, the PWM generator 14 again turns on the current maintaining switch 12 after a predetermined period of time (t₃−t₂). From a time t₃, the flow path of the driving current output from the power source V_{S} is as follows: V_{S}→L→LED light source 20→R_{S}→V_{S}. Thus, the current (refer to ‘B’ of FIG. 3) flowing through the inductor L and the current (refer to ‘C’ of FIG. 3) flowing through the LED light source 20 becomes larger again.

The PWM generator 12 repeatedly turns on and off the current maintaining switch 12 based on the comparison result of the comparison voltage supplied to the current detecting resistor R_{S} and the predetermined order value, and the predetermined period of time. The current flowing in the inductor L and the LED light source 20 maintains “ia”, which is an average value of current “ic” and “ib”.

If the LED light source 20 is turned on at a time t₄, the controller 40 outputs the PWM control signal to turn on the switch 30 as shown in ‘A’ of FIG. 3. As the current flowing in the LED light source 20 at the time t₄ reaches the predetermined current value “ic”, the PWM generator 14 turns off the current maintaining switch 12. From the time t₄, the current charged in the inductor L flows through the diode D through the switch 30 provided in the second path 2b, the current detecting resistor R_{S} and the fourth path 3b. The flow path of the current charged in the inductor L is as follows: L→switch 30→R_{S}→D→L. Thus, the current (refer to ‘Bb’ of FIG. 3) flowing through the inductor L becomes smaller from the time t₄. The current (refer to ‘C’ of FIG. 3) flowing through the LED light source 20 is cut off at the time t₄, and becomes “0”. When the LED light source 20 is turned off, the turn-off response time T₃ of the LED light source 20 becomes shorter and the current (refer to ‘b’ of FIG. 3) flowing in the inductor L becomes smaller regardless of turning on and off the LED light source 20.

After turning off the current maintaining switch 12, the PWM generator 14 again turns on the current maintaining switch 12 after a predetermined period of time. The driving current output from the power source V_{S} is charged in the inductor L through the current maintaining switch 12 to flow to the third path 3a through the switch 30 of the second path 2b and the current detecting resistor R_{S}. The flow path of the driving current output from the power source V_{S} is as follows: V_{S}→L→switch 30→R_{S}→V_{S}. Thus, the current (refer to ‘B’ of FIG. 3) flowing in the inductor L again becomes larger regardless of turning on and off the LED light source 20.

When the LED light source 20 is turned off, the PWM generator 12 repeatedly turns on and off the current maintaining switch 12 based on the comparison result of the comparison voltage supplied to the current detecting resistor R_{S} and the predetermined order value, and the predetermined period of time. The current flowing in the inductor L maintains “ia”, which is an average value of current “ic” and “ib”, regardless of turning on and off the LED light source 20.

If the LED light source 20 is turned on again at a time t₆, the controller 40 outputs the PWM control signal to turn off the switch 30 as shown in (A) of FIG. 3.

As the time t₆ refers to predetermined time after the switch 12 is turned off, the PWM generator 14 turns on the current maintaining switch 12. The current flowing to the inductor L through the path (L→switch 30→R_{S}→D→L) before the time t₆, flows to the LED light source 20 through the path (V_{S}→L→LED light source 20→R_{S}→V_{S}) from the time t₆. As the LED light source 20 receives the current flowing in the inductor L directly at the time t₆, the turn-on response time T₄ of the LED light source 20 becomes shorter when the LED light source 20 is turned on, and the current (refer to ‘b’ of FIG. 3) flowing in the inductor L becomes larger regardless of turning on and off the LED light source 20.

When the LED light source 20 is turned on, the current flowing in the inductor L and the LED light source 20 maintains “ia” through the current maintaining switch 12 turned on and off by the PWM generator 12.

When the display apparatus is turned off by a manipulation of the power key (not shown) of the display apparatus at a time t₈, the controller 40 disables the PWM generator 14 so that the current generator 10 does not output the driving current. Then, the current flowing through the inductor L and the LED light source 20 becomes smaller so as to be “0” at a time t₉.

As described above, the display apparatus according to an exemplary embodiment of the present invention makes the driving current supplied to the LED light source 20 flow through the path (L→switch 30→R_{S}→D→L) or through the path (V_{S}→L→switch 30→R_{S}→V_{S}) when the LED light source 20 is turned off, thereby quickly changing the current supplied to the LED light source 20 into “0” and improving the turn-off response time of the LED light source 20.

Also, the display apparatus according to an exemplary embodiment of the present invention maintains the driving current through the path (L→switch 30→R_{S}→D→L) or through the path (V_{S}→L→switch 30→R_{S}→V_{S}) when the LED light source 20 is turned off. When the LED light source 20 is turned on, the driving current maintained through the path (L→switch 30→R_{S}→D→L) or through the path (V_{S}→L→switch 30→R_{S}→V_{S}) is supplied to the LED light source 20, thereby quickly changing the current supplied to the LED light source 20 into the current “ia” and improving the turn-on response time of the LED light source 20.

While the invention has been shown and described with reference to certain embodiments thereof, it will be understood by those skilled in the art that various changes in form and details may be made therein without departing from the spirit and scope of the invention as defined by the appended claims.

What is claimed is:

1. A display apparatus comprising a light source, further comprising:
a current generator for outputting a predetermined driving current;
a first path for supplying the driving current output by the current generator to the light source;
a second path for intercepting the driving current supplied to the light source;
a switch for supplying the driving current output by the current generator either to the first path or to the second path; and
a controller for controlling the switch to supply the driving current output by the current generator to the first path while the light source is turned on, and to supply the driving current to the second path while the light source is turned off.

2. The display apparatus according to claim 1, wherein the light source comprises a light emitting diode (LED).

3. The display apparatus according to claim 2, wherein the controller outputs a pulse width modulation (PWM) control signal to the switch to turn off the switch so as to supply the driving current output by the current generator to the first path while the light source is turned on, and to turn on the switch so as to supply the driving current to the second path while the light source is turned off.

4. The display apparatus according to claim 3, wherein the controller turns off the switch so as to supply the driving current supplied to the second path, to the light source through the first path when the light source is turned on again while the light source is turned off.

5. The display apparatus according to claim 4, wherein the first path and the second path are provided in parallel with each other, and the switch comprises a transistor which is provided in the second path and controlled to be turned on and off by the controller.

6. The display apparatus according to claim 5, wherein the controller controls the current generator to be disabled when the display apparatus is turned off.

7. The display apparatus according to claim 1, wherein the controller controls the switch to turn off the switch so as to supply the driving current supplied to the second path, to the light source through the first path when the light source is turned on again while the light source is turned off.

8. The display apparatus according to claim 7, wherein the first path and the second path are provided in parallel with each other, and the switch comprises a transistor which is provided in the second path and controlled to turn on and off by the controller.

9. The display apparatus according to claim 8, wherein the controller controls the current generator to be disabled when the display apparatus is turned off.

10. The display apparatus according to claim 1, wherein the first path and the second path are provided in parallel with each other, and the switch is provided in the second path and controlled to be turned on and off by the controller.
